(19) United States
(12) Patent Application Publication
(10) Pub. No.: US 2019/0155559 A1
(43) Pub. Date: May 23, 2019

(54) MULTI-DISPLAY CONTROL APPARATUS AND METHOD THEREOF

(71) Applicants: Mindtronic AI Co.,Ltd., Grand Cayman (KY); Shanghai XPT Technology Limited, Shanghai City (CN)

(72) Inventors: Mu-Jen Huang, Taipei City (TW); Ya-Li Tai, Taoyuan City (TW); Yu-Sian Jiang, Kaohsiung City (TW); Tianle Chen, Shanghai City (CN)

(21) Appl. No.: 16/198,785

(22) Filed: Nov. 22, 2018

(30) Foreign Application Priority Data
Nov. 23, 2017 (CN) 201711185820.2
Nov. 23, 2017 (CN) 201721584752.2

(51) Int. Cl. G06F 3/14; G06F 3/01; G06F 3/0484

(52) U.S. Cl. CPC G06F 3/1423; G06F 3/013; G06F 3/04842; G06F 3/0484; G06F 3/017

(57) ABSTRACT

A multi-display control apparatus includes a plurality of display devices, a sensing module, and a control unit. The sensing module is configured to sense a gaze of a user and a control command. The control unit is electrically connected to the plurality of display devices and the sensing module. The control unit is configured to select a display area of a first display device of the plurality of display devices according to the gaze of the viewer, and move display information in the display area of the first display device to a second display device of the plurality of display devices according to a move command and expand the display information.

### BACKGROUND OF THE INVENTION

### 1. Field of the Invention

The present invention relates to a multi-display control apparatus and method, and more particularly, to a multi-display control apparatus and method capable of moving display information among multiple display devices according to a gaze of a user and a control command.

### 2. Description of the Prior Art

Various displaying devices are provided in vehicles, such as a digital dashboard, a head-up display, a central console display, a rear-seat display, to provide abundant information to users. Those displaying devices are nevertheless independent. The contents displayed on one individual displaying device cannot be shared on another one without a delicately designed equipment.

### SUMMARY OF THE INVENTION

The objective of the present invention is to provide a multi-display control apparatus and control method to solve the problems of the prior arts.

According to one aspect of the present disclosure, a multi-display control apparatus is provided, which includes multiple display devices, a sensing module, and a control unit. The sensing module is configured to sense a gaze and a control command. The control unit is electrically connected to the display devices and the sensing module, and configured to select a display area of a first display device of the display devices according to the gaze of the user, and move display information in the display area of the first display device to a second display device of the display devices according to a move command and expand the display information.

According to another aspect of the present disclosure, a method for controlling a multi-display apparatus including multiple display devices is provided. The method includes the following actions. A sensing module senses a gaze of a user. A control unit selects a display area of a first display device of the display devices according to the gaze of the user. The sensing module senses a control command. The control unit moves display information in the display area of the first display device to a second display device of the display devices according to a move command and expand the display information.

In comparison with the prior art, the multi-display control apparatus of the present disclosure selects the information displayed on a display device according to the gaze of the user, and moves the information to another display device according to the move command, such that the user may read and share information conveniently. In addition, the details of the moved display information may be further expanded, such that the user may browse the content conveniently. Moreover, the multi-display control apparatus of the present disclosure may confirm or exclude the selected display area when selecting the display area according to the confirm or exclude command, so as to reduce the time the user staring at the display device. Therefore, the driver may control the multi-display control apparatus while driving and looking ahead, and thus the traffic accident caused by distraction may be avoided.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a multi-display control apparatus according to an embodiment of the present disclosure.

FIG. 2 is a schematic diagram illustrating the operation of the multi-display control apparatus according to an embodiment of the present disclosure.

FIG. 3 is a schematic diagram of display information on a central console display of FIG. 2 according to an embodiment of the present disclosure.

FIG. 4 is a schematic diagram of moving display information of the multi-display control apparatus according to an embodiment of the present invention.

FIG. 5 is a flowchart of a method for controlling a multi-display apparatus according to an embodiment of the present invention.

### DETAILED DESCRIPTION

When it comes to driving, the driver of a vehicle must be concentrated and always almost keeps the eyesight straight. Important information of the vehicle are usually displayed on a dashboard disposed right in front of the driver, so that the driver can easily appreciate the information without moving his/her eyesight greatly. Modern vehicles usually equip with some sort of communication capabilities. That means a driver may pair his/her cellphone with the vehicle. Consequently, whenever, for instance, a message is received, a notification may prompt to the driver. However, given the displayable size of a display board is limited, important information, such as the current speed, cannot be shielded. Thus, there will be no sufficient area to display the entire content of, for instance, the received message.

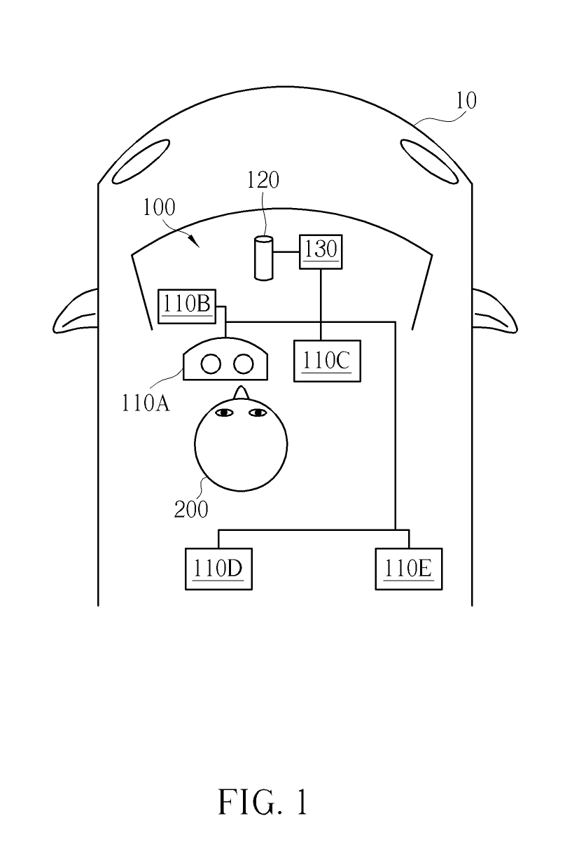

FIG. 1 is a schematic diagram of a multi-display control apparatus 100 according to an embodiment of the present disclosure. As shown, the multi-display control apparatus 100 includes display devices 110A-110E, a sensing module 120 and a control unit 130. In one embodiment, the display devices 110A-110E may be some sort of electronic devices capable of displaying and are disposed in a vehicle 10. For instance, they may include a digital dashboard 110A, a head-up display 110B, a central console display 110C, rear-seat displays 110D-110E. The types of the display devices 110A-110E mentioned above are only for illustrations, and the scope is not limited thereto.

The sensing module 120 is configured to sense a gaze of a user and a control command. For example, the sensing module 120 may include an image capturing device for capturing a facial image or a hand image of the user 200, so as to determine a gaze and a control command according to the face image or the hand image. In one embodiment, the control command may include, but not limited to, a hand gesture, a facial motion, a head motion, a shoulder motion of a user 200. In some embodiments, the sensing module 120 may also be other types of sensors for sensing the gaze and the control command. In some embodiments, the multi-display control apparatus 100 may also include an input interface, e.g., a button, a knob, a microphone, a control panel, a touch screen, a remote control or other elements for receiving other types of commands made by the user 200.

The control unit 130 is electrically connected to the display devices 110A-110E and the sensing module 120. The control unit 130 is configured to select a display area of a first display device according to the gaze of the user, and move the information displayed on the display devices 110A-110E according to a move command made by the user 200. In one embodiment, the control unit 130 may be an intelligent hardware device, such as a central processing unit (CPU), a microcontroller (MCU), or an ASIC. The control unit 130 may process data and instructions. In some embodiments, the control unit 130 is an automotive electronic control unit (ECU).

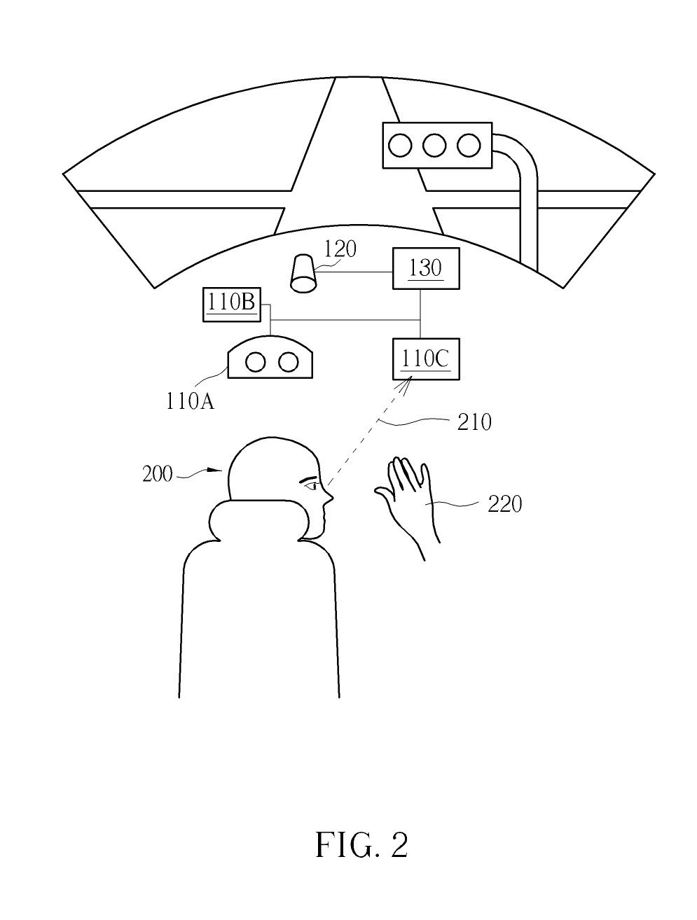

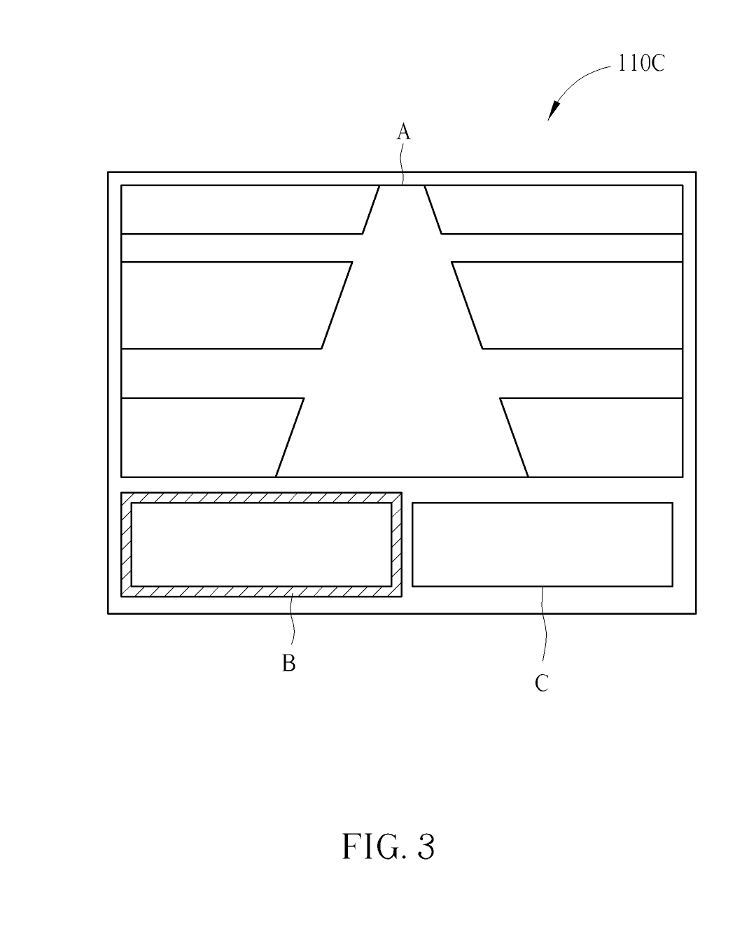

Please refer to FIGS. 2 and 3. FIG. 2 is a schematic diagram illustrating the operation of the multi-display control apparatus 100 according to an embodiment of the present disclosure. In this embodiment, the multi-display control apparatus 100 includes a digital dashboard 110A, a head-up display 110B, and a central console display 110C. FIG. 3 is a schematic diagram of the contents displayed on the central console display 110C according to an embodiment of the present disclosure. As shown in the FIG. 2, when the user 200 is viewing the central console display 110C, the sensing module 120 detects a gaze 210 of the user 200 toward the central console display 110C. For instance, a facial feature is identified based on the facial image or the hand image of the user 200, and then a left eye position and a right eye position is calculated. Accordingly, the gaze (including a gaze direction and a gaze angle) of the user 200 may be obtained.

Next, the control unit 130 selects a corresponding display area on the central console display 110C according to the gaze 210 of the user 200 sensed by the sensing module 120. For example, the central console display 110C has three display areas A, B, C (as shown in FIG. 3) for displaying various contents. In one implementation, the central console display 110C displays a navigation map in a display area A, text messages in the display area B, and news in the display area C. When the sensing module 120 detects the gaze 210 of the user 200 toward the display area B of the central console display 110C, the control unit 130 correspondingly selects the display area B of the central console display 110C. Then, the sensing module 120 senses a control command of the user 200.

In one embodiment, the selected display area is marked or highlighted, for instance, in a different color, in a frame, or in other specific manners to be distinguished from the other display areas. For instance, when the display area B is high-lighted, the user 200 may input a confirm command 220 via the sensing module 120 so as to confirm that the display area B is now selected. In one implementation, the confirm command 220 is a hand gesture (e.g. a first gesture). When the first gesture is sensed by the sensing module 120, the control unit 130 confirms that the display area B is selected. In some embodiments, after the confirmation, even if the gaze 210 of the user is no longer toward the central console display 110C, the control unit 130 may further control the display information on the selected display area B according to the control command of the user 200. On the other hand, when the display area B is highlighted, and an exit command 220 (e.g. a palm opening gesture) is sensed by the sensing module 120, the control unit 130 excludes the display area B from selection. In other words, when the control unit 130 misjudges the gaze 210 of the user 200, the user may exclude the selected region so that the control unit 130 will not select the same display area for a time period to reduce the possibility of misjudgment, and will further select other display areas on the console display 110C according to the gaze 210 of the user 200. In one implementation, the control unit 130 may preferably select other neighboring display areas (e.g. the display area C) after the wrongfully selected display area B is excluded, so as to shorten the selection time. Similarly, the user 200 may input the control command 220 again via the sensing module 120 to confirm or exclude the selected display area multiple times until the desired display area is selected.

Based on the above, when the user 200 issues the confirm command 220 to confirm the selection, the user 200 may stop staring at the display devices, and therefore the time period that the user 200 stares at the display device may be shortened. Therefore, the user 200 may look away from the display device immediately after the selected display area is confirmed, especially when the user 200 is the driver, so as to avoid a traffic accident caused by distraction of the driver. Moreover, when the user 200 issues the exclude command 220 to exclude the selected display area, the control unit 130 avoid selecting the previously selected display area in a time period, so as to reduce the misjudgment repeatedly. In addition, the control unit 130 may preferably select other neighboring display areas to shorten the selection time.

In the present disclosure, the confirm command or the exclude command 220 is not limited to the hand gesture. In some embodiments, the confirm command or the exclude command may include movements of other body parts (e.g. face motion, head motion or shoulder motion) made by the user 200. For instance, the user 200 may confirm or exclude the selected display area by movements such as pouting, opening the mouth, nodding, shaking head, shrugging the shoulder. Moreover, the confirm command or the exclude command 220 may not be limited to the body movements of the user 200, in some other embodiments, the confirm command or the exclude command 220 may also be input signals made by the user via an input interface (e.g., a button, a knob, a microphone, a control panel, a touch screen, a remote control).

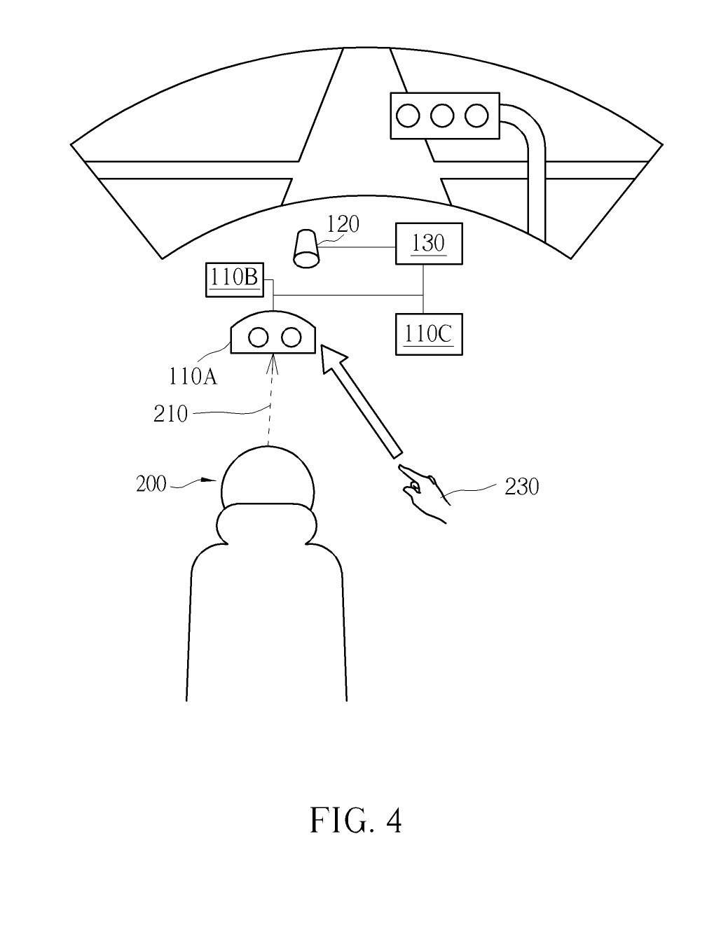

Please refer to FIG. 4, which is a schematic diagram of moving the display information of the multi-display control apparatus 100 according to an embodiment of the present disclosure. As shown in FIG. 4, when the control unit 130 confirms the selected display area (e.g. the display area B) according to the confirm command 220 made by the user 200, the user 200 may issue a move command 230 to move the display the information, where the move command indicates a moving direction. For instance, the moving direction of the move command 230 may be a dragging direction or a pointing direction of a finger or hand of the user 200, but not limited thereto. When the sensing module 120 sensed that the dragging direction of the move command 230 is from bottom right to top left, the control unit 130 determines that a relative position between the head-up display 110B and the central console display 110C corresponds to the moving direction of the move command 230. As such, the control unit 130 moves the information in the display area B of the central console display 110C to the head-up display 110B accordingly. In some embodiments, the control unit 130 may control the central console display 110C to display the original information or some other information in the display area B.

Based on the configurations illustrated above, the multi-display control apparatus 100 of the present disclosure may move the information displayed on one display device to another display device immediately after the move command is sensed. The user 200 may move a selected information (e.g. a text message) to the head-up display 110B or other display devices, especially when the user 200 is the driver, which are convenient for the driver to control the display devices while driving, so as to avoid the traffic accident caused by distraction. In addition, the user 200 may move the information in the selected display area to other display devices viewed by another user (e.g. the rear-seat displays 110D-110E), which are convenient to share the information with another user. Moreover, the vehicle 10 may be equipped with multiple sensing modules, such that multiple users on the vehicle 10 may move and share the displayed information.

Furthermore, the move command 230 is not limited to the hand gestures, which may also be the movements of other body parts of the user 200. For example, the user 200 may shake head to indicate the moving direction of the display information. Alternatively, the moving direction may be determined by tracking the trace of the gaze change. In some embodiments, the move command 230 is a input signal made by the user via an input interface, such as a button, a knob, a microphone, a control panel, a touch screen, a remote control. When the user 200 generates the moving command 230 by the input device, instead of sensing the moving direction of the move command, the move command 230 may directly indicate a target display device, and then the control unit 130 moves the display information to the target display device.

In some embodiments, after the display information is moved, the moved display information may be displayed in a different form from the original display area; for example, the content of the moved display information may be further expanded. In one embodiment, the content of the display information is magnified. In another embodiment, the content of the display information is expanded. In some embodiments, different levels of the display information are displayed. In some other embodiments, additional information is displayed. For example, the digital dashboard 110A may display a simplified navigation map, which cannot be zoomed in or zoomed out, and then the user 200 issues a move command to move the navigation map on the digital dashboard 110A to the display area A of the central console display 110C. Since the display area A of the console displayer 110C is larger than the display area of the digital dashboard 110A, the content of the navigation map on the display area A may be further expanded to display more information. Specifically, the navigation map may be zoomed in or zoomed out to show different hierarchical information. Furthermore, more information such as the neighboring stores and the related information are shown in the navigation map.

In another implementation, the display area B of the central console display 110C displays a text messages with only a few words from the beginning of the text message, and when the control unit 130 moves the text in the display area B of the central console display 110C to the head-up display 110B, the head-up display 110B may expand the content of the text or display the content of the text by scrolling text to show the content of the whole text in the display area B. In addition, the font size of the text may be magnified for clearer viewing.

In some embodiments, the information in the display area is not limited to the navigation map or text messages. The content of the display information is related to one of the multiple display devices and could be shared to another display device. For example, the display devices may display, but not limited to, a speed of the vehicle a rotation speed of an engine of the vehicle, a fuel gauge, a navigation map, apparatus settings, weather information, a calendar, messages, news and emails. In some other embodiments, the information in the display area may include other types of display information.

In another embodiment of the present disclosure, the confirm command 220 may be omitted. In other words, when the control unit 130 selects a display area of a display device according to the gaze 210 of the user 200 sensed by the sensing module 120, the user 200 may directly issues the move command 230 to move the selected display information of the display device to another display device without confirmation. In a case that the user 200 is not the driver, the user 200 does not have to rapidly look back to the front road, the user 200 could look at the display device for longer time. Therefore, since the control unit 130 could have more time to identify and select the desired display area according to the gaze of the user, the chances of misjudgment of the selection could be reduced, and thus there is no need for the control unit to wait for the confirm command.

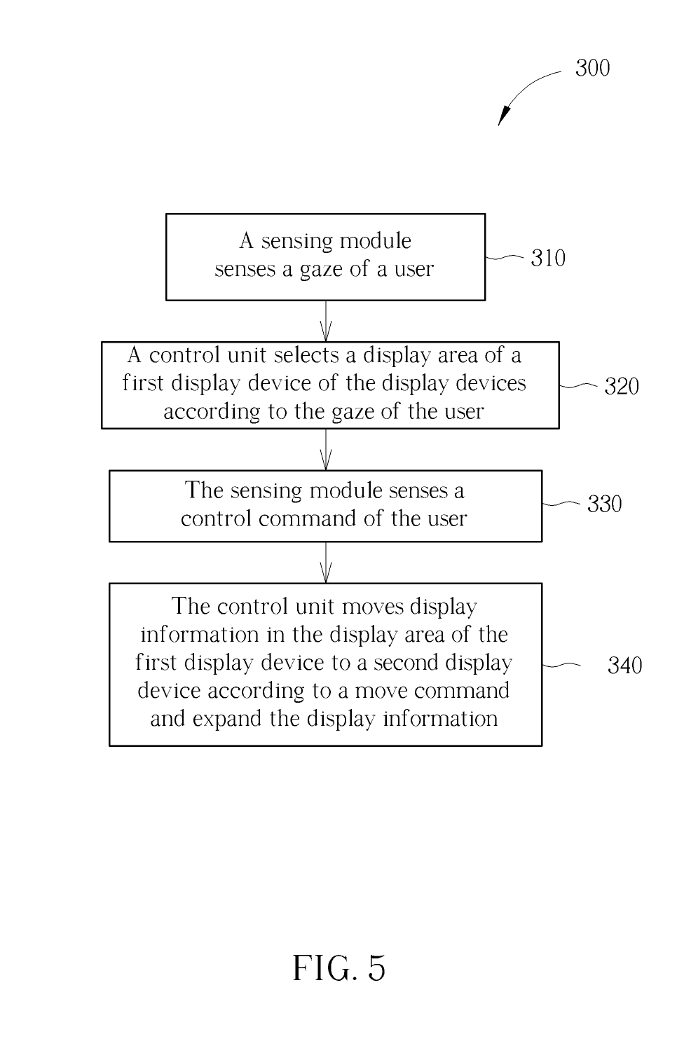

Please refer to FIG. 5, which is a flowchart 300 of a method for controlling a multi-display apparatus according to an embodiment of the present disclosure. The method includes the following actions.

In action 310, a sensing module senses a gaze of a user.

In action 320, a control unit selects a display area of a first display device of the display devices according to the gaze of the user.

In action 330, the sensing module senses a control command of the user.

In action 340, the control unit moves display information in the display area of the first display device to a second display device according to a move command and expand the display information.

In comparison with the prior art, the multi-display control apparatus of the present disclosure may select the information displayed on a display device according to the gaze of the user, and move the information to another display device according to the move command, such that the user may read and share information conveniently. In addition, the details of the moved display information may be further expanded, such that the user may browse the content clearly and conveniently. Moreover, the multi-display control apparatus of the present disclosure may confirm or exclude the selected display area when selecting the display area according to the confirm command or exclude command, so as to reduce the time the user staring at the display device. Therefore, the driver may control the multi-display control apparatus while driving and looking ahead, and thus the traffic accident caused by distraction may be avoided.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multi-display control apparatus, comprising:
a plurality of display devices;
a sensing module configured to sense a gaze of a user and a control command, wherein the control command includes a move command; and
a control unit electrically connected to the plurality of display devices and the sensing module, and the control unit is configured to:
select a display area of a first display device of the plurality of display devices according to the gaze of the user; and
move display information in the display area of the first display device to a second display device of the plurality of display devices according to the move command and expand the display information.

2. The multi-display control apparatus of claim 1, wherein the control command further includes a confirm command, and when selecting the display area of the first display device, the control unit is further configured to:
highlight a first display area of the first display device according to the gaze of the user; and
select the first display area when the confirm command is received.

3. The multi-display control apparatus of claim 1, wherein the control command further includes an exclude command, and when selecting the display area of the first display device, the control unit is further configured to:
highlight a first display area of the first display device according to the gaze of the user; and
exclude the first display area and select a second display area of the first display device when the exclude command is received.

4. The multi-display control apparatus of claim 1, wherein the control command comprises at least one of a hand gesture, a facial motion, a head motion, a shoulder motion, a voice command, and an input signal.

5. The multi-display control apparatus of claim 1, wherein when expanding the display information, the control unit is further configured to:
magnify a content of the display information.

6. The multi-display control apparatus of claim 1, wherein when expanding the display information, the control unit is further configured to:
expand a content of the display information.

7. The multi-display control apparatus of claim 1, wherein when expanding the display information, the control unit is further configured to:
display hierarchical information of the display information.

8. The multi-display control apparatus of claim 1, wherein when expanding the display information, the control unit is further configured to:
display additional information of the display information.

9. The multi-display control apparatus of claim 1, wherein the plurality of display devices are disposed in a vehicle, and the display devices includes at least one of a digital dashboard, a head-up display, a central console display and a rear-seat display.

10. The multi-display control apparatus of claim 1, wherein the display information in the display area comprises at least one of a speed of a vehicle, a rotation speed of an engine of the vehicle, a navigation map, apparatus settings, weather information, a calendar, text messages, news and emails.

11. A method for controlling a multi-display apparatus including
a plurality of display devices, and the method comprises:
sensing, by a sensing module, a gaze of a user;
selecting, by a control unit, a display area of a first display device of the plurality of display devices according to the gaze of the user;
sensing, by the sensing module, a control command of the user, wherein the control command includes a move command; and
moving, by the control unit, display information in the display area of the first display device to a second display device of the plurality of display devices according to the move command and expanding the display information.

12. The method of claim 11, wherein the control command further includes a confirm command, and the step of selecting the display area of the first display device further comprises:
highlighting, by the control unit, a first display area of the first display device according to the gaze of the user; and
selecting, by the control unit, the first display area when the confirm command is received.

13. The method of claim 11, wherein the control command further includes an exclude command, and the step of selecting the display area of the first display device further comprises:
highlighting, by the control unit, a first display area of the first display device according to the gaze of the user; and
excluding, by the control unit, the first display area and selecting a second display area when the exclude command is received.

14. The method of claim 11, wherein the control command comprises at least one of a hand gesture, a facial motion, a head motion, a shoulder motion, a voice command, and an input signal.

15. The method of claim 11, wherein the step of expanding the display information further comprises:
magnifying, by the control unit, a content of the display information.

16. The method of claim 11, wherein the step of expanding the display information further comprises:
expanding, by the control unit, a content of the display information.

17. The method of claim 11, wherein the step of expanding the display information further comprises:
displaying, by the control unit, hierarchical information of the display information.

18. The method of claim 11, wherein the step of expanding the display information further comprises:
displaying, by the control unit, additional information of the display information.

19. The method of claim 11, wherein the plurality of display devices are disposed in a vehicle, and the display devices includes at least one of a digital dashboard, a head-up display, a central console display and a rear-seat display.

20. The method of claim 11, wherein the display information in the display area comprises at least one of a speed of a vehicle, a rotation speed of an engine of the vehicle, a navigation map, apparatus settings, weather information, a calendar, text messages, news and emails.
